(19) United States
(12) Patent Application Publication
(10) Pub. No.: US 2019/0387693 A1
(43) Pub. Date: Dec. 26, 2019

(54) Plant Protector

(71) Applicant: Gnat Shield LLC, Warwick, RI (US)

(72) Inventor: Jon L. Hakanson, North Providence, RI (US)

(73) Assignee: Gnat Shield LLC, Warwick, RI (US)

(21) Appl. No.: 16/448,509

(22) Filed: Jun. 21, 2019

Related U.S. Application Data
(60) Provisional application No. 62/688,004, filed on Jun. 21, 2018.

(51) Int. Cl. A01G 13/02

(52) U.S. Cl. CPC A01G 13/0281; A01G 13/0268

(57) ABSTRACT

A plant protector includes a body having neck portion, a midsection portion, and a gusset portion. The gusset portion includes a first channel with a first cord for cinching the gusset around an open top of a hydroponic container. The neck portion includes a second channel with a second cord for cinching the neck portion around a stalk of a plant growing in the hydroponic container. The midsection portion includes a mesh material that prevents insect infestation.

### RELATED APPLICATIONS

This patent claims priority to and benefit of U.S. Provisional Patent Application No. 62/688,004 (filed Jun. 21, 2018). All documents cited in this section are incorporated here by reference in their entirety.

### FIELD

This disclosure relates to horticulture and, more specifically, plant protectors to prevent or minimize fungus gnat infestation.

### BACKGROUND

Fungus gnats are small flying insects that as adults are harmless to plants and humans. The larvae of the fungus gnat, though, feed on fungus, algae and plant roots. The larvae tunnel through the roots into stems and can harm the health and vitality of plants. In hydroponic gardens, uncontrolled fungus gnats are a detrimental pest that can jeopardize the hydroponic garden. Once an infestation of fungus gnats is discovered, measures to control the infestation can be costly and undesirable. For instance, the user can flush the containers and clean the grow media in the garden or user insecticides. Flushing and cleaning the grow media is time consuming and may further result in damage to the plant roots. Insecticides can be costly and harmful to plants that are grown for consumption.

### SUMMARY

There is a need in the hydroponics industry for a method or device to control the spread of fungus gnats that does not require flushing or use of insecticides.

The plant protector provides a barrier that interrupts the lifecycle of the fungus gnat by preventing the adult fungus gnat from being able to lay eggs in the fluid of the container of the plant, and/or preventing adults from escaping an infected container of a plant to mate and lay eggs. The plant protector includes a mesh or net body that wraps around the open top of the container and the base of the plant. The mesh allows the container to breathe, thus reducing the risk of microbial or fungal growth, and providing a physical barrier against the fungus gnat.

In an embodiment, a plant protector includes a body having neck portion, a midsection portion, and a gusset portion. The gusset portion includes a first channel with a first cord for cinching the gusset around an open top of a hydroponic container. The neck portion includes a second channel with a second cord for cinching the neck portion around a stalk of a plant growing in the hydroponic container. The midsection portion includes a mesh material that prevents insect infestation.

In another embodiment, a plant protector includes a body. The body has a gusset portion having a first channel and a first elastic cord within the first channel to cinch the gusset around a plant pot; a neck portion having a second channel and a second elastic cord within the second channel to cinch the neck portion around a plant stem; and a mesh midsection to enclose an area between the plant pot and the plant stem to prevent insects from entering or exiting the enclosed area. The body includes a slit through the gusset portion, neck portion, and mesh midsection such that, when the slit is in an open position, the plant protection can be positioned around the plant stem and plant pot and, when the slit is in a closed position, the area is enclosed to prevent the insects from entering or exiting the enclosed area. A fastener holds the slit in a closed position.

wherein the body also includes first flaps which, when folded, form the first channel; and second flaps which, when folded, form the second channel;

The mesh midsection comprises holes that are about 1.5 millimeters or smaller.

### BRIEF DESCRIPTION OF THE DRAWINGS

The foregoing features may be more fully understood from the following description of the drawings. The drawings aid in explaining and understanding the disclosed technology. Since it is often impractical or impossible to illustrate and describe every possible embodiment, the provided figures depict one or more exemplary embodiments. Accordingly, the figures are not intended to limit the scope of the invention. Like numbers in the figures denote like elements.

FIG. 1 is a diagram of a plant protector.

FIG. 2 is a diagram of a plant protector covering a plant pot.

FIG. 3 is a diagram of a plant protector.

FIG. 4 is diagram of a body of a plant protector.

FIG. 5 is a diagram of a neck portion of a plant protector.

FIG. 6 is a diagram of a portion of a body of a plant protector.

FIG. 7 is a diagram of a hydroponic garden utilizing plant protectors.

### DETAILED DESCRIPTION

The examples of the apparatus discussed herein are not limited in application to the details of construction and the arrangement of components set forth in the following description or illustrated in the accompanying drawings. It will be understood to one of skill in the art that the apparatus is capable of implementation in other embodiments and of being practiced or carried out in various ways. Examples of specific embodiments are provided herein for illustrative purposes only and are not intended to be limiting. Also, the phraseology and terminology used herein is for the purpose of description and should not be regarded as limiting. Any references to examples, embodiments, components, elements or acts of the apparatus herein referred to in the singular may also embrace embodiments including a plurality, and any references in plural to any embodiment, component, element or act herein may also embrace embodiments including only a singularity (or unitary structure). References in the singular or plural form are not intended to limit the presently disclosed apparatus, its components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

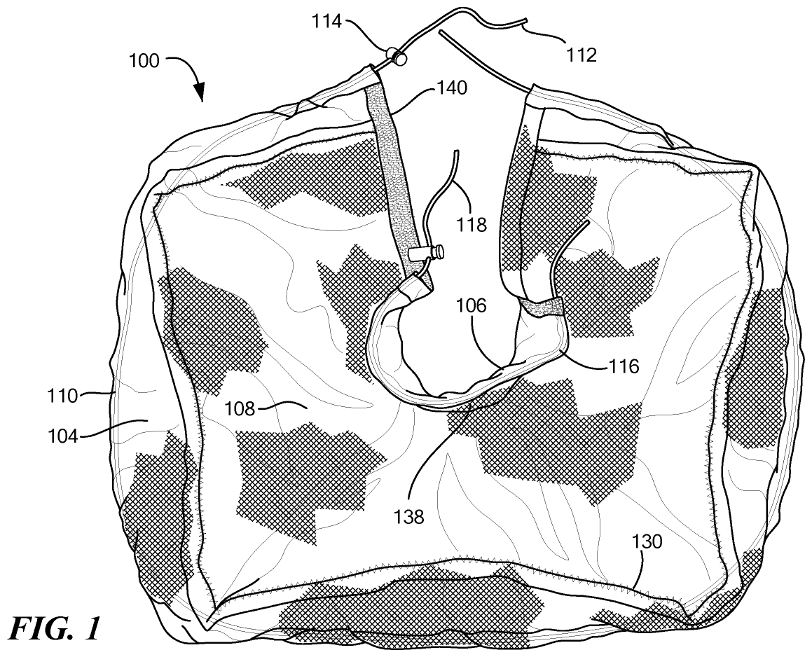

Referring now to FIG. 1, plant protector 100 includes a body 102 that has a gusset portion 104, a neck portion 106, and a midsection portion 108. Gusset portion 104 includes a channel 110 and a cord 112 through the channel 110. In embodiments, cord 112 may be an elastic cord and may include a fastener, such as cinch fastener 114, to tighten and hold cord 112 around a plant pot.

In embodiments, neck portion 106 may also include a channel 116 and a cord 118. In embodiments, cord 118 may also be an elastic cord and may also include a fastener (not shown) to tighten and hold cord 118 around the stem of a plant or trunk of a tree that is in the plant pot.

In embodiments, midsection 108 may be formed from a mesh material so that, when gusset portion 104 is closed around a plant pot and neck portion 106 is closed around a plant stem, midsection 108 may enclose the area between the plant pot and the plant stem to prevent insects from entering or exiting the enclosed area. Adult fungus gnats have a body size about 1.5 mm. Therefore, the mesh may be a relatively tight mesh with holes that are less than about 1.5 mm in size to prevent fungus gnats from traveling through the mesh. In embodiments, the holes in the mesh may be significantly smaller than 1.5 mm in size.

In some cases, plant protector 100 may include piping 130. Piping 130 may be used for aesthetic purposes. Also, piping 130 may add strength to the mesh to prevent tearing of body 102 during handling or use.

The body 102 may be formed from a number of materials, such as polypropylene, polyester, nylon, polyester with elastic cord. Gross-grain ribbon may be stitched at the seams between the neck portion and midsection, and/or the midsection and gusset of the body to add to the overall appearance and strengthen the connection between the sections of the body. A bias hem technique may be used to stitch the section tougher.

Plant protector 100 has a generally rectangular shape so that it can fit over standard sized 16-inch by 14-inch plant pots. In other embodiments, plant protector 100 may have a round shape, a triangular shape, or other shape to fit over differently shaped plant pots.

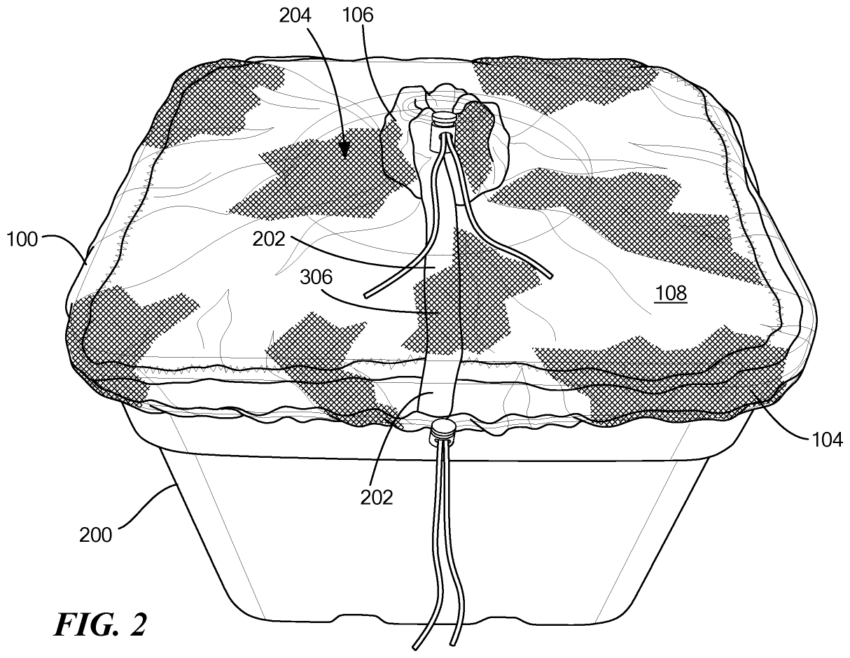

Referring to FIG. 2, plant protector 100 is in a closed position placed on a plant pot 200. As shown, there may be a slit 202 through the gusset portion 104, neck portion 106, and mesh midsection 108 so that, when slit 202 is open, the plant protector 100 can be positioned around the stem of a plant and the plant pot 200 and, when slit 202 is closed, the area 204 between the plant and the plant pot 200 (i.e. the area inside plant pot 200) is enclosed to prevent the insects from entering or exiting plant pot 200.

If plant pot 200 has a lip or other extrusion round its rim, gusset portion 104 may be hooked around the lip or extrusion and cinched. This may act to secure the plant protector in place and reduce the chance that the plant protector is accidentally removed from the plant pot.

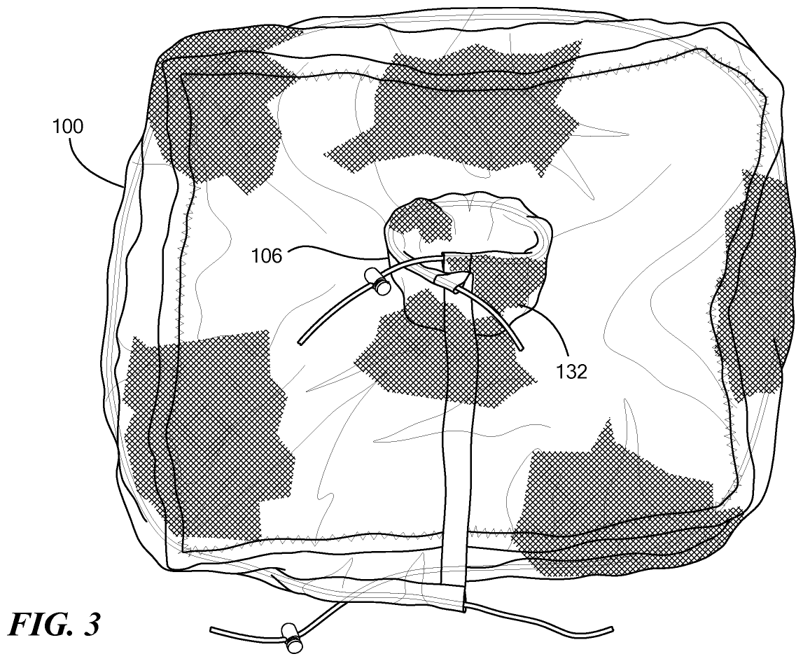

Referring also to FIG. 3, plant protector 100 is again shown in a closed position. Fastener 306 may be included to hold slit 202 in a closed position. In embodiments, fastener 206 may be a hook and loop fastener having a strip with hooks attached to one side of the slit 202 and a strip with loops attached to the other side of the slit 202. When the two sides of the strip meet, the hook and loop strips fasten together to hold slit 202 closed. In other embodiments, slit 202 may be held together with a zipper. Other types of fasteners could be used, by way of example and not limitation, zippers, buttons, tape, and clips.

Plant protector 100 may include a collar 132 coupled to or formed as part of neck portion 106. In embodiments, collar 132 may be a rigid or semi-rigid tubular structure that can enclose around a plant stem. Collar 132 may include a hook and loop fastening mechanism and/or a drawstring (e.g. an elastic cord) to close collar 132 around the plant stem.

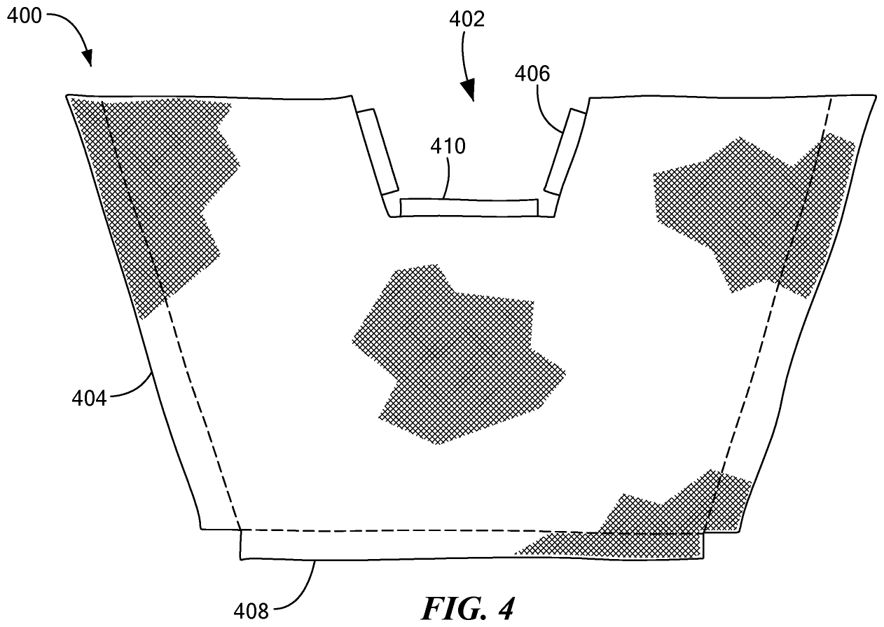

Referring to FIG. 4, body 400 may be the same as or similar to the body of plant protector 100. Body 400 is shown in a flattened state. For example, body 400 may be cut or formed from mesh fabric, then assembled to form a plant protector with gusset, midsection, and neck as described above.

In embodiments, body 400 may have a substantially trapezoidal shape and may include a trapezoidal recess 402. The outer edges 404 may form the plant protector's gusset and the inner edges 406 of recess 402 my form the plant protector's neck.

Body 400 may include outer flaps (e.g. flap 408), which may be folded over and stitched to form a hem. When stitched, the outer flaps may form a channel (e.g. channel 110 in FIG. 1) through which cord 112 may be placed. Similarly, inner neck flaps (e.g. flap 410) may be folded over to form a hem. When stitched, the inner neck flaps may form channel 116 through which cord 118 may be placed. Although shown as separate and distinct flaps, outer flaps 408 may be a single flap around the outer perimeter of body 400. Similarly, inner neck flaps 410 may be a single flap around the perimeter of recess 402.

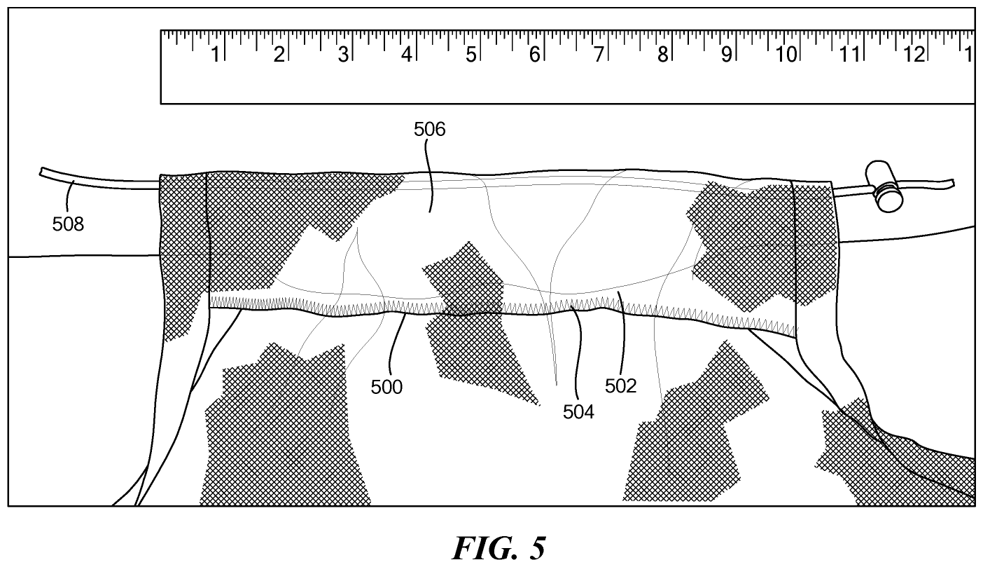

Referring to FIG. 5, neck portion 500 may be the same as or similar to neck portion 106 in FIG. 1. Neck portion 500 may be formed from a flap 502 that is folded over and secured with stitches 504 to form a channel 506. Cord 508 may be placed within channel 506 prior to stitching or may be threated through channel 506 after the stitching is completed. As shown, neck portion 500 may have a length of about 10.5 inches. When neck portion 500 is formed into a cylinder, the cylinder may have a circumference of about 10.5 inches.

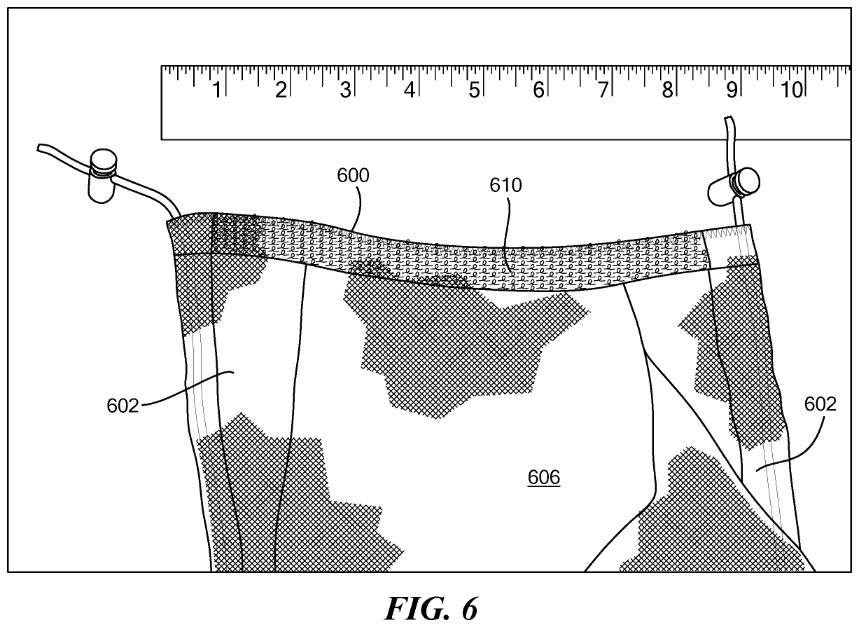

Referring to FIG. 6, a portion of the body of a plant protector is shown. Edge 600 may be the same as or similar to edge 140 (see FIG. 1) and may form one side of slit 202 (see FIG. 2). Edge 600 may also form the terminal edge of gusset 602, midsection 604, and neck portion 606. As shown, edge 600 may be about 9.5 inches in length.

Edge 600 is shown as including fastener strip 610, which may be one side of a hook and loop faster, as described above.

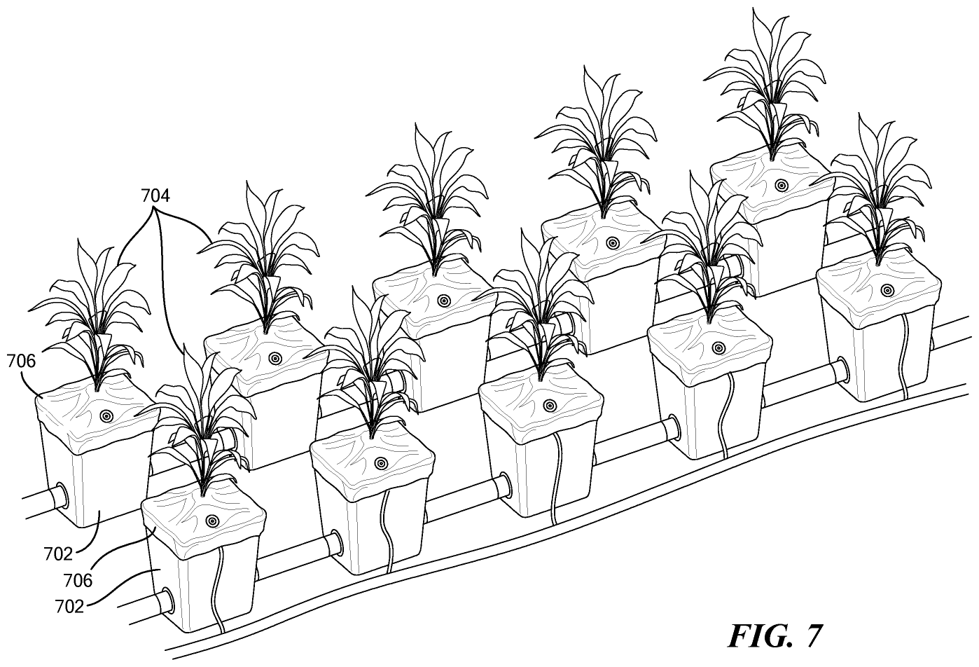

Referring to FIG. 7, a hydroponic garden 700 is shown with a plurality of plant pots 702, each containing a plant 704. Each plant pot 702 and plant 704 is protected by a plant protector 706, which may be the same as or similar to plant protector 100 (see FIG. 1).

Plant protectors 706 may be cinched around the stems of plants 704 and also around the outer edge of the plant pots 702 so that insects cannot enter or exit the plant pots. For example, if a healthy plant is brought into an environment that has insects such as fungus gnats, the plant protector can prevent the healthy plant from becoming infested by the insects. Likewise, if a plant pot has been infested with insects, the plant protector can prevent the insects from exiting the plant pot and infesting other plants in the facility.

Thus, various embodiments of the plant protector provide a unique and novel solution to the problem of controlling and reducing populations of fungus gnats in hydroponic gardens. Because the plant protector securely wraps around the open top of the container, access to the fluid in the container is blocked. If an infected container is brought into a hydroponic garden, as the larvae mature into adults they cannot escape the plant, feed, mate and reproduce, thus interrupting the life cycle of the fungus gnat. If a healthy plant is brought into a hydroponic garden that has adult fungus gnats present, the fungus gnats cannot gain access to the fluid in the container to lay their eggs, thereby interrupting the lifecycle. As a result, the population of fungus gnats in a hydroponic garden may be effectively controlled and reduced. Consequently, the overall health and yield of the plant in the hydroponic garden is increased.

Those skilled in the art will appreciate that the conception, upon which this disclosure is based, may readily be utilized as a basis for designing other products without departing from the spirit and scope of the invention as defined by the appended claims. Therefore, the claims are not to be limited to the specific examples depicted herein. For example, the features of one example disclosed above can be used with the features of another example. Furthermore, various modifications and rearrangements of the parts may be made without departing from the spirit and scope of the underlying inventive concept. For example, the geometric configurations disclosed herein may be altered depending upon the application, as may the material selection for the components. Thus, the details of these components as set forth in the above-described examples, should not limit the scope of the claims.

Having described preferred embodiments, which serve to illustrate various concepts, structures and techniques, which are the subject of this patent, it will now become apparent to those of ordinary skill in the art that other embodiments incorporating these concepts, structures and techniques may be used. Accordingly, it is submitted that that scope of the patent should not be limited to the described embodiments but rather should be limited only by the spirit and scope of the following claims. All references cited herein are hereby incorporated herein by reference in their entirety.

1. A plant protector for a hydroponic container, plant protector comprising:
a body having neck portion, a midsection portion, and a gusset portion;
the gusset portion including a first channel with a first cord for cinching the gusset around an open top of a hydroponic container;
the neck portion including a second channel with a second cord for cinching the neck portion around a stalk of a plant growing in the hydroponic container.

2. The plant protector of claim 1 wherein the body portion is formed from a mesh material.

3. The plant protector of claim 2 wherein the mesh material comprises one or more of: a polypropylene mesh, a polyester mesh, and a nylon mesh.

4. The plant protector of claim 1 wherein the mesh comprises holes having a size of about 1.5 millimeters or smaller.

5. The plant protector of claim 1 further comprising a gross-grain ribbon attached to the midsection portion.

6. The plant protector of claim 1 further comprising a slit through the body.

7. The plant protector of claim 6 wherein the body comprises a fastener to close the slit.

8. The plant protector of claim 7 wherein the fastener is a hook and loop fastener or a zipper fastener comprising a first strip along a first edge of the slit and a second strip along a second edge of the slit.

9. The plant protector of claim 1 wherein the first cord, the second cord, or both comprise an elastic material.

10. The plant protector of claim 1 wherein the gusset comprises a rectangular shape.

11. The plant protector of claim 10 wherein the rectangular shape has dimensions of about 16 inches or larger by about 14 inches or larger.

12. The plant protector of claim 1 wherein the body has one or more flaps which, when folded, form the second channel.

13. The plant protector of claim 1 wherein the body has one or more flaps which, when folded, form the first channel.

14. The plant protector of claim 1 wherein the gusset comprises a substantially circular shape.

15. The plant protector of claim 1 wherein the body has a trapezoidal shape.

16. The plant protector of claim 14 wherein the body comprises a trapezoidal recess forming an upper peripheral edge of the body.

17. The plant protector of claim 1 further comprising colored piping.

18. The plant protector of claim 1 wherein the gusset portion comprises bias hem.

19. The plant protector of claim 1 wherein the neck portion comprises a bias hem.

20. A plant protector comprising:
a body comprising:
a gusset portion having a first channel and a first elastic cord within the first channel to cinch the gusset around a plant pot;
a neck portion having a second channel and a second elastic cord within the second channel to cinch the neck portion around a plant stem; and
a mesh midsection to enclose an area between the plant pot and the plant stem to prevent insects from entering or exiting the enclosed area;
a slit through the gusset portion, neck portion, and mesh midsection such that, when the slit is in an open position, the plant protection can be positioned around the plant stem and plant pot and, when the slit is in a closed position, the area is enclosed to prevent the insects from entering or exiting the enclosed area; and
a fastener to hold the slit in a closed position;
wherein the body comprises:
first flaps which, when folded, form the first channel; and
second flaps which, when folded, form the second channel;
wherein the mesh midsection comprises holes that are about 1.5 millimeters or smaller.
